(19) United States
(12) Patent Application Publication
(10) Pub. No.: US 2026/0139636 A1
(43) Pub. Date: May 21, 2026

(54) INTERNAL COMBUSTION ENGINE

(71) Applicant: TOYOTA JIDOSHA KABUSHIKI KAISHA, Toyota-shi (JP)

(72) Inventor: Hiroaki KOSAKA, Toyota-shi (JP)

(73) Assignee: TOYOTA JIDOSHA KABUSHIKI KAISHA, Toyota-shi (JP)

(21) Appl. No.: 19/391,344

(22) Filed: Nov. 17, 2025

(30) Foreign Application Priority Data
Nov. 20, 2024 (JP) 2024-202715

(51) Int. Cl. F02D 19/06

(52) U.S. Cl. CPC F02D 19/0678; F02D 19/0607; F02D 19/0644; F02D 19/0665; F02D 19/0671

(57) ABSTRACT

An internal combustion engine includes a tank that stores liquid fuel, a cylinder, an intake port connected to the cylinder, a port injection valve that injects fuel into the intake port, a pressurizer that pressurizes fuel vapor in the tank, and a low-pressure passage that connects the pressurizer and the port injection valve to each other.

### CROSS-REFERENCE TO RELATED APPLICATIONS

This application is based upon and claims the benefit of priority from Japanese Patent Application No. 2024-202715, filed on November 20, 2024, the entire contents of which are incorporated herein by reference.

### BACKGROUND

### 1. Field

The present disclosure relates to an internal combustion engine.

### 2. Description of Related Art

JP2024-125574A discloses a hydrogen supply device including a tank that stores liquid fuel and a vaporizer that converts liquid hydrogen in the tank into gaseous hydrogen.

In the tank, the liquid fuel evaporates to generate fuel vapor. The generation of fuel vapor causes the pressure inside the tank to rise. When the pressure inside the tank exceeds a certain value, the fuel vapor is released to the atmosphere. When the fuel vapor is discharged, the amount of fuel available for supply to the internal combustion engine is reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an internal combustion engine includes a tank that stores liquid fuel, a cylinder, an intake port connected to the cylinder, a port injection valve that injects fuel into the intake port, a pressurizer that pressurizes fuel vapor in the tank, and a low-pressure passage that connects the pressurizer and the port injection valve to each other.

Other features and aspects will be apparent from the following detailed description, the drawings, and the claims.

### BRIEF DESCRIPTION OF THE DRAWINGS

FIG. 1 is a diagram schematically showing a configuration of an internal combustion engine according to an embodiment.

FIG. 2 is a flowchart showing a procedure of a fuel supply process executed by a controller.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

The configuration of the internal combustion engine 1 will be described with reference to Fig.

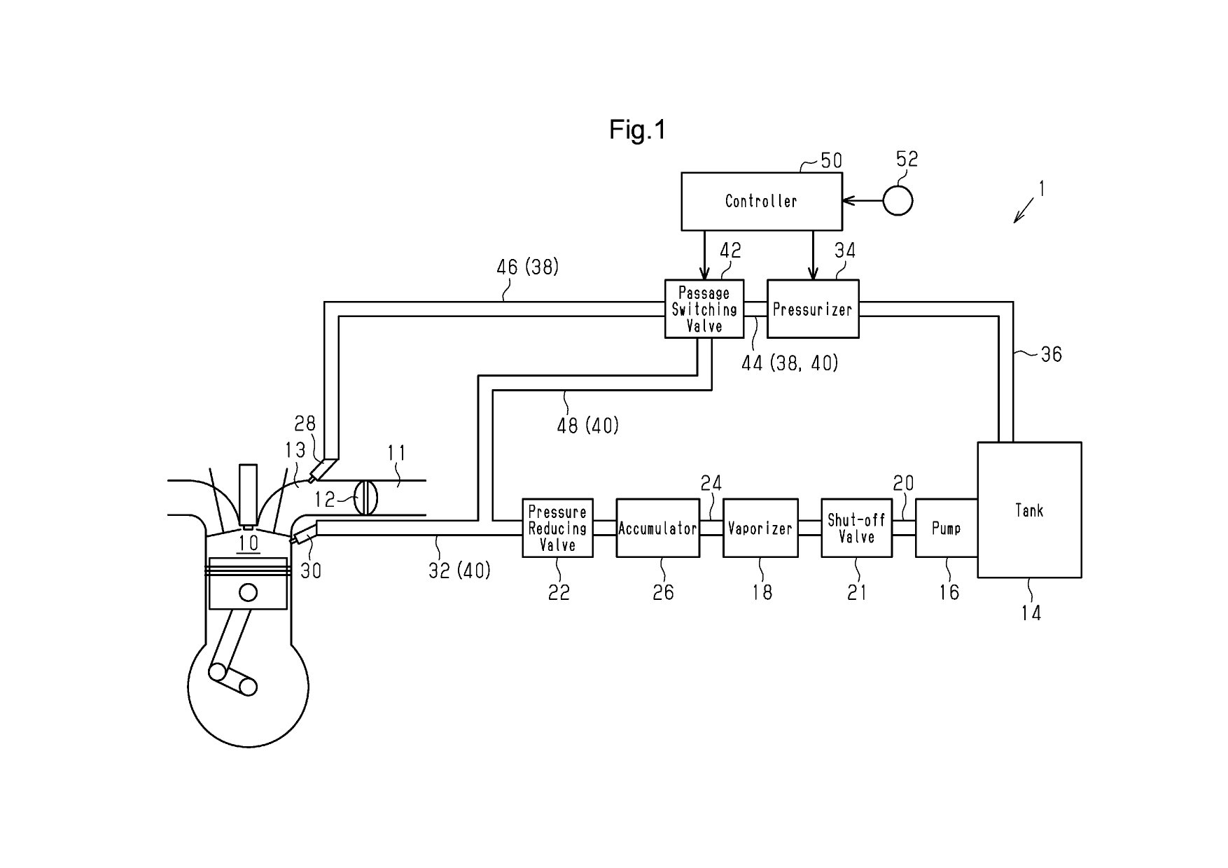

As shown in FIG. 1, the internal combustion engine 1 includes a cylinder 10, an intake passage 11, and a throttle valve 12 provided in the intake passage 11. The intake passage 11 includes an intake port 13 connected to the cylinder 10. The air flows into the cylinder 10 through the intake passage 11. The amount of intake air flowing through the intake passage 11 is adjusted in accordance with the opening degree of the throttle valve 12. In the cylinder 10, a mixture of air and fuel introduced from the intake port 13 is combusted. Thus, the internal combustion engine 1 generates power.

### Gaseous Fuel

The internal combustion engine 1 includes a tank 14 that stores liquid fuel, a pump 16 that pumps out the liquid fuel in the tank 14, a vaporizer 18 that converts the liquid fuel into gaseous fuel, and a liquid fuel passage 20 that connects the pump 16 and the vaporizer 18.

The pump 16 pumps out the liquid fuel in the tank 14 and supplies the liquid fuel to the vaporizer 18 through the liquid fuel passage 20. A part of the pump 16 may be provided in the tank 14. The liquid fuel passage 20 has a shut-off valve 21. The shut-off valve 21 can shut off the supply of the liquid fuel from the pump 16 to the vaporizer 18. An example of the liquid fuel is hydrogen. Other examples of liquid fuels are liquefied natural gas, liquefied petroleum gas.

The vaporizer 18 vaporizes the liquid fuel and converts it into gaseous fuel. For example, the vaporizer 18 converts the liquid fuel into the gaseous fuel by heat exchange between a heating medium circulating between the vaporizer 18 and a heat source and the liquid fuel. The heat source may be cooling water of the internal combustion engine 1 or may be a heater that can be heated by an electric current. The heat medium may be a gas such as helium or a liquid such as water.

The internal combustion engine 1 includes a pressure reducing valve 22 that reduces the pressure of the gaseous fuel, and a vaporization passage 24 that connects the vaporizer 18 and the pressure reducing valve 22. The vaporization passage 24 has an accumulator 26. The accumulator 26 stores the high-pressure gaseous fuel supplied from the vaporizer 18. The pressure reducing valve 22 reduces the pressure of the gaseous fuel supplied from the vaporizer 18 through the accumulator 26.

The internal combustion engine 1 includes a port injection valve 28 that injects fuel into the intake port 13, a direct injection valve 30 that injects fuel into the cylinder 10, and a gaseous fuel passage 32 that connects the pressure reducing valve 22 and the direct injection valve 30. The gaseous fuel passage 32 supplies the gaseous fuel decompressed by the pressure reducing valve 22 to the direct injection valve 30. The port injection valve 28 injects low-pressure (for example, about several hundred kPa) fuel into the intake port 13. The direct injection valve 30 injects fuel into the cylinder 10 at a pressure (for example, about several MPa) higher than the fuel injection pressure of the port injection valve 28.

### Fuel Vapor

The internal combustion engine 1 includes a pressurizer 34 that pressurizes fuel vapor evaporated in the tank 14, a fuel vapor passage 36 that connects the pressurizer 34 and the tank 14 to each other, a low-pressure passage 38 that connects the pressurizer 34 and the port injection valve 28 to each other, a high-pressure passage 40 that connects the pressurizer 34 and the direct injection valve 30 to each other, and a passage switching valve 42. Although the tank 14 is thermally insulated and maintained at a low temperature, a part of the liquid evaporates due to heat, shaking of the liquid surface, or the like. The fuel vapor is supplied from the tank 14 to the pressurizer 34 through the fuel vapor passage 36. The pressurizer 34 pressurizes the fuel vapor to a pressure suitable for injection of fuel from the port injection valve 28 (hereinafter referred to as a port injection pressure). Further, the pressurizer 34 pressurizes the fuel vapor to a pressure suitable for injection of fuel from the direct injection valve 30 (hereinafter referred to as a direct injection pressure).

The gaseous fuel and the fuel vapor are gases changed in state from the liquid fuel, and are distinguished as follows in the present disclosure. That is, the gaseous fuel is a gas generated when the liquid fuel is vaporized by the vaporizer 18. The fuel vapor is a gas generated by evaporation of the liquid fuel in the tank 14.

The low-pressure passage 38 includes a common passage 44 that connects the pressurizer 34 and the passage switching valve 42, and a low-pressure branch passage 46 that connects the passage switching valve 42 and the port injection valve 28. The high-pressure passage 40 includes the common passage 44, a high-pressure branch passage 48 connecting the passage switching valve 42 and the gaseous fuel passage 32, and the gaseous fuel passage 32. Both the low-pressure passage 38 and the high-pressure passage 40 include a common passage 44. The passage switching valve 42 branches the common passage 44 into a low-pressure branch passage 46 and a high-pressure branch passage 48.

The fuel vapor pressurized by the pressurizer 34 is supplied to the passage switching valve 42. The valve position of the passage switching valve 42 can be switched between a low-pressure position and a high-pressure position. At the low-pressure position, the pressurizer 34 and the low-pressure passage 38 are connected to each other, and the pressurizer 34 and the high-pressure passage 40 are disconnected from each other. At the high-pressure position, the pressurizer 34 and the high-pressure passage 40 are connected to each other, and the pressurizer 34 and the low-pressure passage 38 are disconnected from each other.

The passage switching valve 42 can selectively supply the fuel vapor supplied from the pressurizer 34 to the low-pressure passage 38 and the high-pressure passage 40 by switching the valve position. When the valve position of the passage switching valve 42 is the low pressure position, the fuel vapor is supplied from the pressurizer 34 to the port injection valve 28 through the low-pressure passage 38. When the valve position of the passage switching valve 42 is the high-pressure position, the fuel vapor is supplied to the direct injection valve 30 through the high-pressure passage 40. The direct injection valve 30 injects the gaseous fuel decompressed by the pressure reducing valve 22. The direct injection valve 30 injects the fuel vapor pressurized by the pressurizer 34.

### Controller

The internal combustion engine 1 includes a controller 50. The controller 50 is configured to be able to control the pressurizer 34 and the passage switching valve 42. The controller 50 can acquire the load state of the internal combustion engine 1. The internal combustion engine 1 has a measuring instrument 52. The controller 50 can acquire the state quantity of each of the gaseous fuel and the fuel vapor from the measuring instrument 52. The state quantity includes, for example, at least one of the pressure, the temperature, and the flow rate of the gaseous fuel and the fuel vapor flowing through the high-pressure passage 40 and the low-pressure passage 38, respectively. The measuring instrument 52 is installed, for example, in each of the high-pressure passage 40 and the low-pressure passage 38. The measuring instrument 52 that measures the state quantity of the fuel vapor may be installed in the tank 14 or the pressurizer 34.

The controller 50 controls the pressurizer 34 and the passage switching valve 42 based on the acquired load state of the internal combustion engine 1 and the acquired state quantity of the fuel vapor. The controller 50 can control the pressurizer 34 to adjust the pressure of the fuel vapor supplied from the pressurizer 34 to the high-pressure passage 40 and the low-pressure passage 38. The controller 50 switches the valve position of the passage switching valve 42 between the low-pressure position and the high-pressure position. When the valve position of the passage switching valve 42 is the low-pressure position, the fuel vapor pressurized by the pressurizer 34 is supplied to the port injection valve 28 through the low-pressure passage 38. When the valve position of the passage switching valve 42 is the high-pressure position, the fuel vapor pressurized by the pressurizer 34 is supplied to the direct injection valve 30 through the high-pressure passage 40. The controller 50 can change the supply destination of the fuel vapor by controlling the passage switching valve 42.

### Operation of the Embodiment

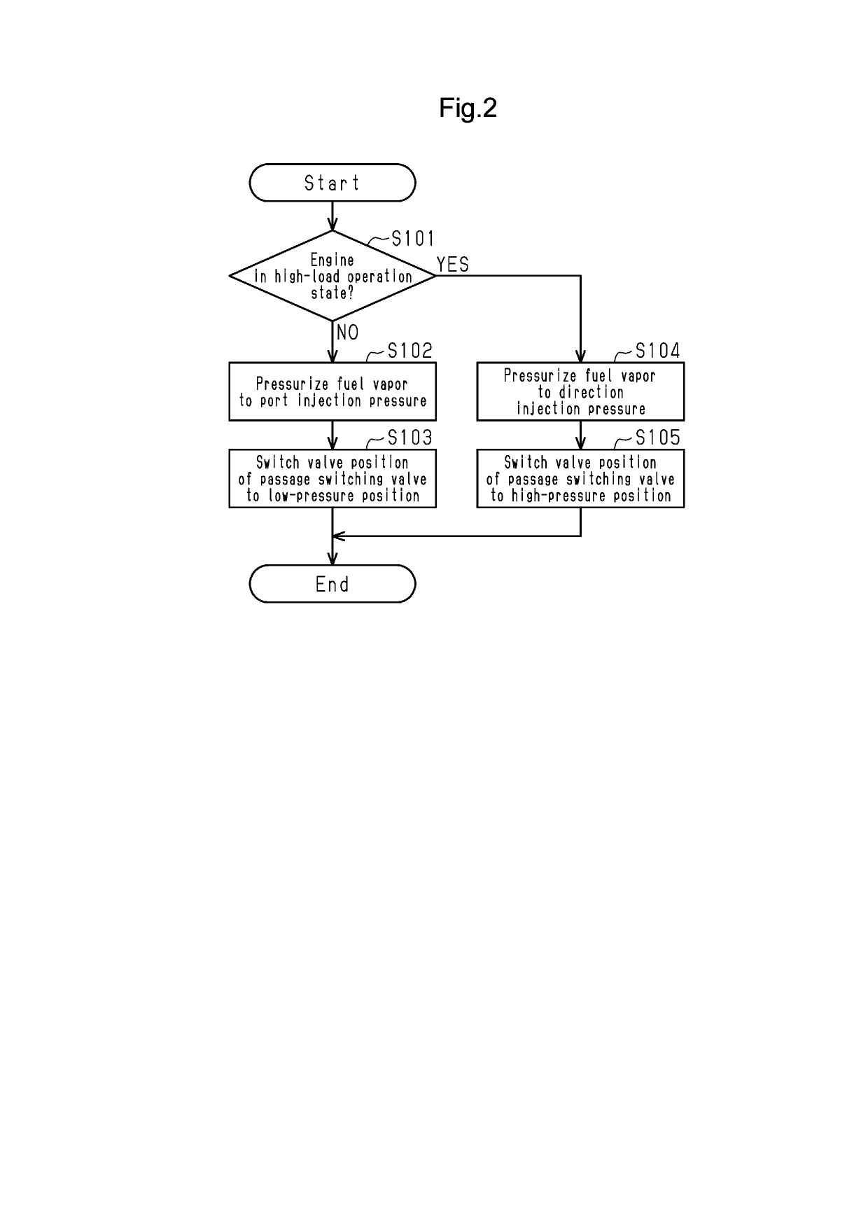

Next, a procedure of a fuel vapor supply process executed by the controller 50 will be described with reference to FIG. 2.

When the fuel vapor supply process is started, the controller 50 determines whether the internal combustion engine 1 is in a high-load operation state in step S101. For example, the controller 50 determines that the internal combustion engine 1 is in the high-load operation state when the load factor of the internal combustion engine 1 is greater than or equal to a specified value. The load factor is defined, for example, as the ratio of the actual amount of air flowing into the cylinder 10 at the time of the determination in step S101 to the maximum amount of air that would flow into the cylinder 10 if the throttle valve 12 were fully opened. When determining that the internal combustion engine 1 is not in the high-load operation state (S101: NO), the internal combustion engine 1 is in a low-load operation state, and thus the controller 50 advances the process to step S102. When the internal combustion engine 1 is in the high-load operation state (S101: YES), the controller 50 advances the process to step S104.

In step S102, the controller 50 controls the pressurizer 34 such that the fuel vapor pressure becomes equal to the port injection pressure. Thereafter, the controller 50 advances the process to step S103.

In step S103, the controller 50 controls the passage switching valve 42 such that the valve position of the passage switching valve 42 is set to the low-pressure position. As a result, the pressurizer 34 and the port injection valve 28 are connected to each other, so that fuel vapor is supplied to the port injection valve 28.

When the internal combustion engine 1 is in the high load state (S101: YES), the controller 50 controls the pressurizer 34 such that the fuel vapor pressure becomes the direct injection pressure in step S104. Thereafter, the controller 50 advances the process to step S105.

In step S105, the controller 50 controls the passage switching valve 42 such that the valve position of the passage switching valve 42 is set to the high-pressure position. As a result, the pressurizer 34 and the direct injection valve 30 are connected to each other, and fuel vapor is supplied to the direct injection valve 30. In summary, during the high-load operation of the internal combustion engine 1, the controller 50 controls the pressurizer 34 such that the pressure of the fuel vapor pressurized by the pressurizer 34 is higher than that during the low-load operation. Further, the controller 50 controls the passage switching valve 42 such that the valve position of the passage switching valve 42 is set to the high-pressure position.

When step S103 or step S105 is completed, a series of the fuel vapor supply process is completed. The order of step S102 and step S103 may be reversed, or step S102 and step S103 may be performed simultaneously. Similarly, the order of step S104 and step S105 may be reversed, or step S104 and step S105 may be performed simultaneously.

### Advantages of the Present Embodiment

(1) In the internal combustion engine 1 of the present disclosure, the fuel vapor in the tank 14 is pressurized by the pressurizer 34 and then supplied to the port injection valve 28 through the low-pressure passage 38. The fuel vapor can be used as fuel for the internal combustion engine 1 by injecting the fuel vapor into the intake port 13 from the port injection valve 28.

(2) In the internal combustion engine 1 of the present disclosure, the fuel vapor in the tank 14 is pressurized by the pressurizer 34 and then supplied to the direct injection valve 30 through the high-pressure passage 40. The fuel vapor can be used as fuel for the internal combustion engine 1 by injecting the fuel vapor into the cylinder 10 from the direct injection valve 30.

(3) By switching the valve position of the passage switching valve 42, the internal combustion engine 1 of the present disclosure selectively uses the fuel vapor injected by the port injection valve 28 and the fuel vapor injected by the direct injection valve 30 as the fuel for the internal combustion engine 1.

(4) When the internal combustion engine 1 is in the high-load operation state, more fuel is required and the time during which fuel can be injected is shorter than when the internal combustion engine 1 is in the low-load operation state. The port injection pressure is lower than the direct injection pressure. As a result, when an attempt is made to inject fuel from the port injection valve 28 during high-load operation, there is a possibility that the time for fuel injection will be insufficient, so that the injection amount of fuel will be insufficient.

In this regard, during high-load operation, the controller 50 of the internal combustion engine 1 according to the present disclosure pressurizes the fuel vapor to a high pressure and supplies it to the direct injection valve 30. When fuel is injected from the direct injection valve 30, the direct injection pressure is higher than the port injection pressure. Accordingly, compared with fuel injection from the port injection valve 28, a larger amount of fuel is injected within the same amount of time. As a result, even when the internal combustion engine 1 is in the high-load operation, fuel vapor can be used as the fuel for the internal combustion engine 1.

On the other hand, if the evaporated fuel were pressurized to a high pressure and supplied to the direct injection valve 30 regardless of the load state of the internal combustion engine 1, the workload of the pressurizer 34 required to pressurize the fuel vapor would become excessive. In this regard, during low-load operation, the controller 50 of the internal combustion engine 1 according to the present disclosure supplies fuel vapor to the port injection valve 28. This reduces the workload of the pressurizer 34 necessary to pressurize the fuel vapor.

### Modifications

The above-described embodiment may be modified as follows. The above-described embodiment and the following modifications can be combined as long as the combined modifications remain technically consistent with each other.

A configuration without the high-pressure passage 40 may be employed. In this configuration, the internal combustion engine 1 supplies the fuel vapor pressurized by the pressurizer 34 only to the port injection valve 28. Further, the controller 50 may be able to pressurize the fuel vapor to the port injection pressure by controlling the pressurizer 34.

A configuration that does not include the passage switching valve 42 can be adopted. In an example of this configuration, for example, the common passage 44 is connected to each of the low-pressure passage 38 and the high-pressure passage 40, and a check valve is provided in the high-pressure passage 40. The check valve opens to connect the common passage 44 to the gaseous fuel passage 32 when the pressure in the portion of the high-pressure passage 40 upstream of the check valve increases to the direct injection pressure. As a result, the fuel vapor pressurized to the direct injection pressure by the pressurizer 34 is supplied to the direct injection valve 30 and then injected into the cylinder 10 from the direct injection valve 30.

When the pressure in the portion of the high-pressure passage 40 downstream of the check valve is higher than the pressure in the portion upstream of the check valve, the check valve closes to disconnect the common passage 44 and the gaseous fuel passage 32 from each other. As a result, the fuel vapor pressurized to the port injection pressure by the pressurizer 34 is supplied to the port injection valve 28, and then injected into the intake port 13 from the port injection valve 28.

When the pressurizer 34 incorporates the passage switching valve 42, a configuration in which the common passage 44 is omitted can be adopted. In this configuration, the low-pressure passage 38 connects the pressurizer 34 and the port injection valve 28. The high-pressure passage 40 includes a high-pressure branch passage 48 and a gaseous fuel passage 32. The high-pressure passage 40 connects the pressurizer 34 and the direct injection valve 30.

A configuration including multiple pressurizers can be adopted. An example of this configuration includes, for example, a first pressurizer that pressurizes the fuel vapor to the port injection pressure and a second pressurizer that pressurizes the fuel vapor to the direct injection pressure. In this configuration, the first pressurizer pressurizes the fuel vapor supplied from the tank 14 to the port injection pressure and supplies the pressurized fuel vapor to the port injection valve 28. The second pressurizer pressurizes the fuel vapor supplied from the tank 14 to a direct injection pressure and supplies the pressurized fuel vapor to the direct injection valve 30.

A configuration including a port fuel passage connecting the pressure reducing valve 22 and the port injection valve 28 can be adopted. In this configuration, a passage switching valve is provided. The gaseous fuel passage 32 includes a common passage that connects the pressure reducing valve 22 and the passage switching valve, and a passage that connects the passage switching valve and the direct injection valve 30. The port fuel passage includes a common passage and a passage that connects the passage switching valve and the port injection valve 28. The passage switching valve can selectively supply the gaseous fuel supplied from the pressure reducing valve 22 to the gaseous fuel passage 32 and the port fuel passage by switching the valve position. The pressure reducing valve 22 reduces the pressure of the gaseous fuel to a direct injection pressure and supplies the gaseous fuel to the direct injection valve 30 through the gaseous fuel passage 32. The pressure reducing valve 22 reduces the pressure of the gaseous fuel to a port injection pressure, and supplies the gaseous fuel to the port injection valve 28 through the port fuel passage.

The controller 50 is not limited to a device including processing circuitry that includes a CPU and a ROM and executes software processing. That is, the controller 50 may be modified if it has any one of the following configurations (a) to (c).

(a) The controller 50 includes one or more processors that execute various processes according to computer programs. Each processor includes a CPU and a memory, such as a RAM and a ROM. The memory stores program codes or instructions configured to cause the CPU to execute processes. The memory, or a computer-readable medium, includes any type of medium that is accessible by general-purpose computers and dedicated computers.

(b) The controller 50 includes one or more dedicated hardware circuits that execute various processes. Examples of the dedicated hardware circuits include an application specific integrated circuit (ASIC) and a field programmable gate array (FPGA).

(c) The controller 50 includes a processor that executes part of various processes according to programs and a dedicated hardware circuit that executes the remaining processes.

What is claimed is:

1. An internal combustion engine, comprising:
a tank that stores liquid fuel;
a cylinder;
an intake port connected to the cylinder;
a port injection valve that injects fuel into the intake port;
a pressurizer that pressurizes fuel vapor in the tank; and
a low-pressure passage that connects the pressurizer and the port injection valve to each other.

2. The internal combustion engine according to claim 1, further comprising:
a direct injection valve that injects fuel into the cylinder of the internal combustion engine;
a vaporizer that converts the liquid fuel into a gaseous fuel;
a pressure reducing valve that reduces a pressure of the gaseous fuel;
a gaseous fuel passage that connects the pressure reducing valve and the direct injection valve to each other; and
a high-pressure passage that connects the pressurizer and the direct injection valve to each other.

3. The internal combustion engine according to claim 2, further comprising a passage switching valve, wherein
a valve position of the passage switching valve is switchable between
a low-pressure position at which the passage switching valve connects the pressurizer and the low-pressure passage to each other and disconnects the pressurizer and the high-pressure passage from each other, and
a high-pressure position at which the passage switching valve connects the pressurizer and the high-pressure passage to each other and disconnects the pressurizer and the low-pressure passage from each other.

4. The internal combustion engine according to claim 3, further comprising a controller that includes processing circuitry,
wherein the processing circuitry is configured to
during a low-load operation of the internal combustion engine, control the passage switching valve such that the valve position of the passage switching valve is set to the low-pressure position, and
during a high-load operation of the internal combustion engine, control the pressurizer such that a pressure of the fuel vapor pressurized by the pressurizer is higher than that during the low-load operation, and control the passage switching valve such that the valve position of the passage switching valve is set to the high-pressure position.
